(19) United States
(12) Patent Application Publication
(10) Pub. No.: US 2024/0397067 A1
(43) Pub. Date: Nov. 28, 2024

(54) ADAPTIVE VIDEO THINNING BASED ON LATER ANALYTICS AND RECONSTRUCTION REQUIREMENTS

(71) Applicant: Telefonaktiebolaget LM Ericsson (publ), Stockholm (SE)

(72) Inventors: Mitra DAMGHANIAN, Upplands-Bro (SE); Jacob STRÖM, Stockholm (SE); Christopher HOLLMANN, Uppsala (SE); Per WENNERSTEN, Årsta (SE)

(73) Assignee: Telefonaktiebolaget LM Ericsson (publ), Stockholm (SE)

(21) Appl. No.: 18/695,903

(22) PCT Filed: Sep. 16, 2022
(86) PCT No.: PCT/EP2022/075856

§ 371 Date: Mar. 27, 2024

Related U.S. Application Data
(60) Provisional application No. 63/251,182, filed on Oct. 1, 2021.

(51) Int. Cl. H04N 19/29; H04N 19/172; H04N 19/42; H04N 19/70

(52) U.S. Cl. CPC H04N 19/29; H04N 19/172; H04N 19/42; H04N 19/70

(57) ABSTRACT

A method (400) for thinning a video comprising a sequence of pictures. The method includes the deciding whether or not to perform a video thinning process on a picture of the video. The method also includes performing a video thinning process on the picture of the video as a result of deciding to perform a video thinning process. The method also includes deciding whether or not to perform a video thinning process on another picture of the video. The method also includes, after deciding not to perform a video thinning process on the another picture, encoding the another picture to produce an encoded picture. The method further includes adding the encoded picture to a bitstream.

### TECHNICAL FIELD

This disclosure relates to video thinning.

### BACKGROUND

### 1. Video Compression

A video consists of a series of pictures (a.k.a., images or frames). Accordingly, a video is often referred to as a video sequence. Each picture of a video sequence consists of one or more components. Each component can be described as a two-dimensional rectangular array of sample values (a.k.a., pixel values or pixels for short). It is common that a picture consists of three components: one luma component (Y) where the pixel values are luma values, and two chroma components (Cb and Cr), where the pixel values are chroma values. Components are sometimes referred to as “color components.”

Video is the dominant form of data traffic in today's networks and is projected to still increase its share. One way to reduce the data traffic per video is compression. Here a video is encoded to a bitstream comprising an encoded video, which then can be stored and transmitted to end users. Using a decoder, the end user can extract the video data and display it on a screen. However, since the encoder may not know what kind of device the encoded bitstream is going to be sent to, the encoder typically compresses the video according to a standardized compression scheme and format. Then all devices which support the chosen standard can decode the video.

Compression can be lossless, i.e., the decoded video will be identical to the source given to the encoder, or lossy, where a certain degradation of content is accepted. This has a significant impact on the bitrate, i.e., how high the compression ratio is, as factors such as noise can make lossless compression quite expensive.

### 2. Commonly Used Video Coding Standards

Video standards are usually developed by international organizations. The currently most applied video compression standard is H.264/AVC which was jointly developed by ITU-T and ISO. The first version of H.264/AVC was finalized in 2003, with several updates in the following years. The successor of H.264/AVC, which was also developed by ITU-T and ISO, is known as H.265/HEVC (High Efficiency Video Coding) and was finalized in 2013.

High Efficiency Video Coding (HEVC) is a block-based video codec and utilizes both temporal and spatial prediction. Spatial prediction is achieved using intra (I) prediction from within the current picture. Temporal prediction is achieved using uni-directional (P) or bi-directional inter (B) prediction on block level from previously decoded reference pictures. In the encoder, the difference between the original pixel data and the predicted pixel data, referred to as the residual, is transformed into the frequency domain, quantized and then entropy coded before transmitted together with necessary prediction parameters such as prediction mode and motion vectors, also entropy coded. The decoder performs entropy decoding, inverse quantization and inverse transformation to obtain the residual, and then adds the residual to an intra or inter prediction to reconstruct a picture.

MPEG and ITU-T have finished the successor to HEVC within the Joint Video Exploratory Team (JVET). The name of this video codec is Versatile Video Coding (VVC) and version 1 of the VVC specification has been published as Rec. ITU-T H.266 ISO/IEC 23090-3, “Versatile Video Coding” 2020.

### 3. Picture Order Count (POC)

A picture in HEVC and VVC is identified by is picture order count (POC) value. Both the encoder and the decoder keep track of the POC and assign POC values to each picture that is encoded/decoded.

There are three commonly used types of pictures: an I-frame, a P-frame, and a B-frame. An I-frame is coded independently from all other frames and can be decoded without having reference pictures. A video usually begins with an I-frame. P-frames and B-frames use inter prediction from other frames. A P-frame can predict from one other frame, whereas a B-frame can predict from at least one other frame. It does not matter what type the referenced frame is, for instance, it is quite common to predict from I-frames as these are usually coded with high quality.

### 4. Structure of a Compressed Video

A coded video sequence starts with an independently coded image (e.g., an I-frame). After that, there are typically several frames which predict from at least one other frame, which we call B-frames. Typically, the coding is done hierarchically. First frame 0 is coded, then frame 16 which predicts from 0, then frame 8 which predicts from 0 and 16, and so on. This is known as a group of pictures (GOP) structure.

A GOP structure defines how pictures can reference each other and the per-picture specific configuration. The GOP can be divided into temporal sub layers as shown in FIG. 7. In the example, there are 5 temporal sub layers, with the IDs (TId) 0-4. Pictures at a certain temporal sub layer may not reference pictures at a higher temporal sub layer. The figure illustrates a typical GOP structure for Random Access in HEVC. Each GOP has 16 pictures starting with a picture at TId 0. The arrows illustrate the references so, e.g., POC 8 is used as reference for POC 4, 6, 7, 9, 10 and 12. The decode order, i.e., the order that the pictures are processed by the decoder, is typically optimized so that referenced pictures are coming as close as possible to a picture to minimize latency and memory usage.

### SUMMARY

Certain challenges presently exist. For instance, many videos, even after they are compressed, generally consist of a large amount of data and it can be costly to transmit and/or store such a large amount of data. Moreover, some of the video data may be less important than (i.e., have a lower priority than) other portions of the video data. In use cases where a video is primarily aimed at being used in a machine vision task, some pictures or image details that are expensive to transmit and/or store do not always contribute to the quality or accuracy of the machine vision task performed on the decoder side. These pictures or image details are sometimes not even needed for human consumption of the decoded video.

Accordingly, in one aspect there is provided a video encoding method for thinning a video comprising a sequence of pictures. The video encoding method includes deciding whether or not to perform a video thinning process on a picture of the video. The method also includes performing a video thinning process on the picture of the video as a result of deciding to perform a video thinning process. The method also includes deciding whether or not to perform a video thinning process on another picture of the video. The method also includes, after deciding not to perform a video thinning process on the another picture, encoding the another picture to produce an encoded picture. The method further includes adding the encoded picture to a bitstream.

In another aspect there is provided a computer program comprising instructions which when executed by processing circuitry of a video encoding apparatus, causes the video encoding apparatus to perform the video encoding methods disclosed herein. In another aspect there is provided a carrier containing the computer program, wherein the carrier is one of an electronic signal, an optical signal, a radio signal, and a computer readable storage medium.

In another aspect there is provided a video encoding apparatus where the video encoding apparatus is adapted to perform the video encoding methods disclosed herein. In some embodiments, the video encoding apparatus includes processing circuitry and a memory containing instructions executable by the processing circuitry, whereby the video encoding apparatus is operative to perform the video encoding methods disclosed herein.

In another aspect there is provided a video decoding method for decoding an encoded video, wherein at least one picture of the video was subject to a video thinning process and the picture included a machine vision feature. The method includes obtaining a bitstream comprising the encoded video. The method also includes identifying a rule for reconstructing the machine vision feature. The method further includes using the rule and information obtained from the bitstream to reconstruct the machine vision feature.

In another aspect there is provided a computer program comprising instructions which when executed by processing circuitry of a video decoding apparatus, causes the video decoding apparatus to perform the video decoding methods disclosed herein. In another aspect there is provided a carrier containing the computer program, wherein the carrier is one of an electronic signal, an optical signal, a radio signal, and a computer readable storage medium.

In another aspect there is provided a video decoding apparatus where the video decoding apparatus is adapted to perform any of the video decoding methods disclosed herein. In some embodiments, the video decoding apparatus includes processing circuitry and a memory containing instructions executable by the processing circuitry, whereby the video decoding apparatus is operative to perform the video decoding methods disclosed herein.

An advantage of the embodiments is that that make a better usage of the bandwidth for transmission and storage of video content. This can be in the form of a smaller total required bandwidth or, in some embodiments, an increased accuracy of the machine vision task in the decoder. This is obtained through a better tradeoff in the form of spending more bandwidth on the video details crucial for the machine vision task and less bandwidth on the less important video details. Additionally, a thinned video bitstream might be decoded faster compared to the original bitstream due to potentially lower number of pictures and/or higher quantization parameters. Also, a thinned video bitstream might be decoded with less amount of energy and/or processing power compared to the original bitstream due to potentially lower number of pictures. This can be important for use cases where the decoding resources have hard limits.

### BRIEF DESCRIPTION OF THE DRAWINGS

The accompanying drawings, which are incorporated herein and form part of the specification, illustrate various embodiments.

FIG. 1 illustrates a system according to an embodiment.

FIG. 2 is a schematic block diagram of a video encoder according to one embodiment.

FIG. 3 is a schematic block diagram of a video decoder according to one embodiment.

FIG. 4 is a flowchart illustrating a process according to an embodiment.

FIG. 5 is a flowchart illustrating a process according to an embodiment.

FIG. 6 is a block diagram of an apparatus according to an embodiment.

FIG. 7 illustrates a hierarchical GOP-structure.

### DETAILED DESCRIPTION

As noted above, a video may consist of a large amount of data and some of this data (e.g., certain pictures of the video) may be of marginal value, particular in the context of a machine vision application. Accordingly, this disclosure provides a video encoder that is operable to “thin” a video. Thinning a video in this context means “removing” data from the video (particularly the low value data). Removing such low value data makes a better usage of transmission bandwidth and storage space and does not significantly deteriorate a machine vision task may be performed on the decoder side. The thinning process includes: (1) encoding only a subset of the pictures (i.e., removing pictures): (2) using a relatively high quantization parameter (QP) for encoding and decoding the less important frames; and/or (3) encoding high priority pictures in lower resolution.

### Machine Vision

Machine vision is a technology that is increasingly used in both industrial and consumer applications. In general, machine vision applications take input from a sensor, usually a camera, perform some sort of processing and provide an output. The scope of applications is very wide, including: barcode scanners, product inspection at assembly lines, augmented reality application for phones, and decision making in self-driving cars.

The processing in machine vision applications can be done by different algorithms running on different hardware. In certain applications, a simple digital signal processor might suffice, whereas, in other cases, one or more graphics processing units (GPUs) are required. In recent years, processing the input with neural networks has gained a lot of ground due to the versatility of neural networks and their often-superior performance over other machine vision methods.

The result produced by the processing algorithm can also vary quite much. A barcode scanner in a store could give you a product number, a product inspection system might tell whether a product is faulty, an augmented reality application on a phone could give you a filtered picture with additional information, and an algorithm in a self-driving car might give you an indication whether the vehicle needs to reduce speed or not.

In short, there are many different tasks that can be performed by machine vision algorithms, including, for example:
(1) Object detection-objects in the input image or video are located corresponding to their position and size. It is also possible to extract information about the nature of the detected objects. This can for example be used in automated tagging of image databases;
(2) Object tracking-based on the object detection task, objects are traced through different frames of the input video. An example application is a surveillance system in a store that tracks the movement of customers;
(3) Object segmentation—an image or video is divided into different regions, with regions being easier to analyze or process. For example, applications that replace the background in a video stream use segmentation; and
(4) Event detection-based on the input, the algorithm determines if there is a certain type of event happening, for example a system in a car might detect whether another car is changing its lane.

### RELATED APPLICATIONS

A video encoder can analyze one or more frames and then make decisions based on the detected content to adjust encoding parameters. An example of an implementation of such a system is described in: Axis Communications, “Axis Zipstream technology”, Whitepaper, January 2018 (available at host=www (dot) axis (dot) com:path=/files/whitepaper/:filename=wp_zipstream_71496_en_1801_lo.pdf). Here three different aspects of the encoding can be adjusted:
(1) Region of Interest (ROI)—a part of the video is encoded with higher quality than the remaining video;
(2) Group of Pictures (GOP)—based on the content, I-frames (which are independent from other frames) can be omitted to reduce the bitrate when very little motion is detected; and
(3) Frames per Second (fps)—when little change in the content is detected, the number of encoded frames per second can be reduced. In some cases, this might be solved by sending empty frames (frames only consisting of skip blocks) instead of the actual video frames to keep the appearance of a constant frame rate up.

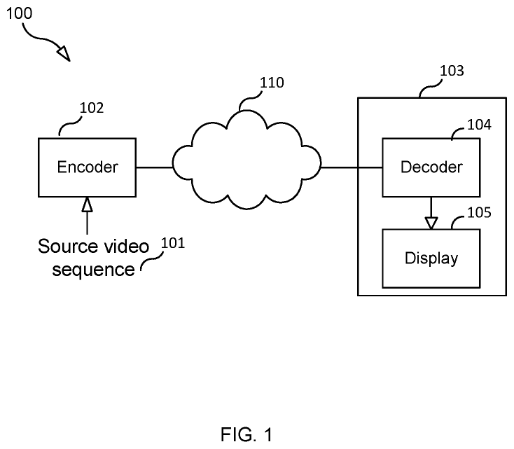

FIG. 1 illustrates a system 100 according to an embodiment. System 100 includes a video encoder 102 and a video decoder 104, wherein the encoder 102 is in communication with the decoder 104 via a network 110 (e.g., the Internet or other network). That is, encoder 102 encodes a video sequence 101 into a bitstream comprising an encoded video sequence and transmits the bitstream to decoder 104 via network 108. In some embodiments, rather than transmitting bitstream to decoder 104, the bitstream is stored in a data storage unit.

The decoder decodes the pictures included in the encoded video sequence to produce video data for display. Accordingly, decoder 104 may be part of a device 103 having a display device 105. The device 103 may be a mobile device, a set-top device, a head-mounted display, and the like.

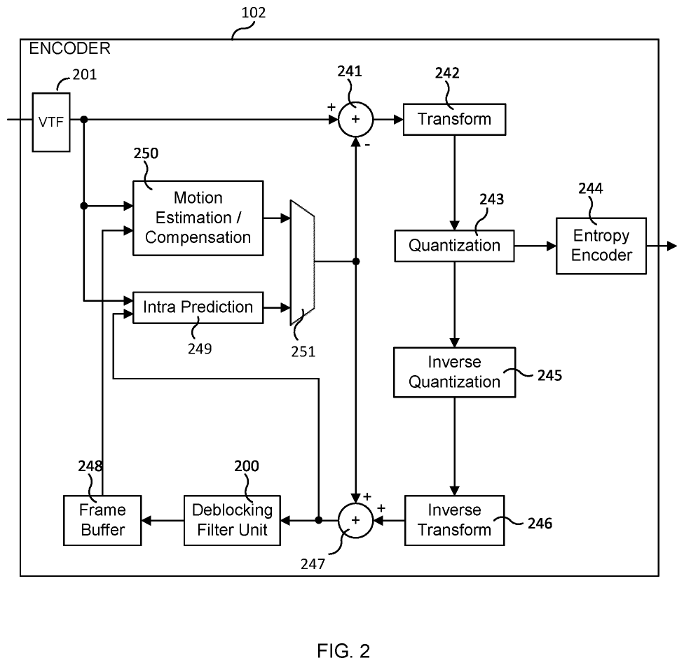

FIG. 2 illustrates video encoder 102 according to an embodiment. In this embodiment, video encoder 102 includes a video thinning function (VTF) 201. Video thinning function 201 receives the pictures of the source video and analyzes the pictures to determine whether or not a video thinning process should be performed on the picture. That is, for example, VTF 201 determines whether the picture is a “low priority” picture. In one embodiment, a picture of the video is either a “high priority” (i.e., a picture for which video thinning is not applied) or a “low priority” picture (i.e., a picture to which a video thinning process is applied). In one particular embodiment, the video thinning process consists of dropping the picture—i.e., each low priority picture is dropped while each high priority picture is output for further processing (in some embodiments, however, even low priority pictures are output for further processing).

In the embodiment shown, each picture output from VTF 201 is passed to a motion estimation/compensation block 250 and an intra predictor 249. The outputs from the motion estimation/compensation block 250 and the intra predictor 249 are input to selector 251 that either selects intra prediction or inter prediction for the current block of pixels. The output from the selector 251 is input to an error calculator in the form of adder 241 that also receives the pixel values of the current block of pixels. Adder 241 calculates and outputs a residual error as the difference in pixel values between the block of pixels and its prediction. The error is transformed in transformer 242, such as by a discrete cosine transform, and quantized by quantizer 243 followed by coding in encoder 244, such as by entropy encoder. In inter coding, also the estimated motion vector is brought to encoder 244 to generate the coded representation of the current block of pixels. The transformed and quantized residual error for the current block of pixels is also provided to an inverse quantizer 245 and inverse transformer 246 to retrieve the original residual error. This error is added by adder 247 to the block prediction output from the motion compensator 250 or intra predictor 249 to create a reference block of pixels that can be used in the prediction and coding of a next block of pixels. This new reference block is first processed by a deblocking filter 200 that filters blocking artifacts. The processed new reference block is then temporarily stored in frame buffer 248, where it is available to intra predictor 249 and motion estimator/compensator 250).

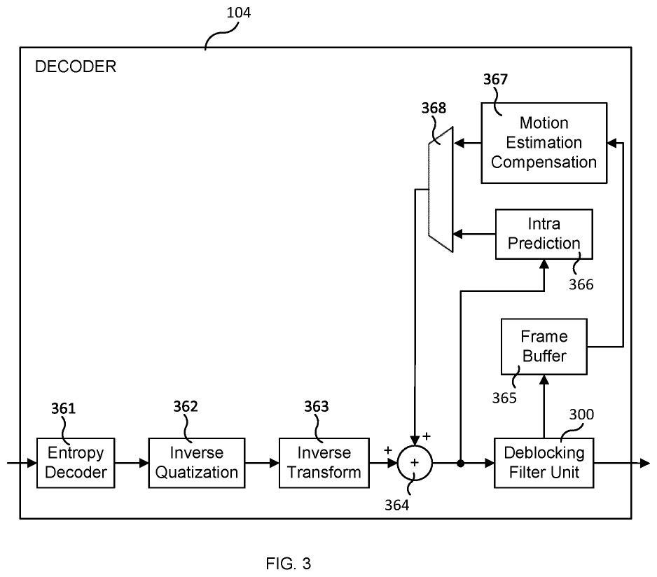

FIG. 3 is a schematic block diagram of decoder 104 according to some embodiments. The decoder 104 comprises a decoder 361, such as entropy decoder, for decoding an encoded representation of a block to get a set of quantized and transformed residual errors. These residual errors are dequantized in an inverse quantizer 362 and inverse transformed by an inverse transformer 363 to get a set of residual errors. These residual errors are added in an adder 364 to the pixel values of a reference block. The reference block is determined by a motion estimator/compensator 367 or intra predictor 366, depending on whether inter or intra prediction is performed. A selector 368 is thereby interconnected to the adder 364 and the motion estimator/compensator 367 and the intra predictor 366. The resulting decoded block output form the adder 364 is input to a deblocking filter unit 300 (which may perform the same functions as filter unit 200 of encoder 102). The filtered block is output form the decoder 104 and is furthermore preferably temporarily provided to a frame buffer 365 and can be used as a reference block for a subsequent block to be decoded. The frame buffer 365 is thereby connected to the motion estimator/compensator 367 to make the stored blocks of pixels available to the motion estimator/compensator 367. The output from the adder 364 is preferably also input to the intra predictor 366 to be used as an unfiltered reference block.

### Video Thinning Function (VTF) 201

As noted above, in one embodiment, encoder 102 includes VTF 201, and, in one particular embodiment, only a subset of the video pictures are encoded and decoded per normal procedures (e.g., only the non-low priority pictures) while the pictures determined to be low priority are subject to a video thinning process—e.g., the low priority picture are dropped or encoded in a particular way that results in a thinning of the video. The VTF 201 thus, in embodiment, decides, for each input picture, a priority level to assign to the picture (e.g., VTF 201 determines whether or not the picture is low priority). The VTF 201 decision for determining a picture to be low priority may be based on, but not limited to, one or more of the following.

In one embodiment, for each input picture. VTF 201 obtains (e.g., calculates) a similarity measure that indicates the degree to which the picture is similar to one or more other pictures (previous or future pictures). If the similarity measure is greater than a threshold, then the picture is determined to be a low priority picture—i.e., subject to video thinning. There are many known ways for determining a similarity measure. For example, VTF 201 in one embodiment calculates a mean squared error (MSE) by calculating: MSE=(1/n)SUM[(Ai−Bi)²], for i=1 to n, where Ai is the ith pixel of picture A and Bi is the ith pixel for picture B. The MSE provides a similarity measure that indicates the similarity between picture A and picture B. In another embodiment, VTF 201 uses the MSE to calculate a peak signal-to-noise ratio (PSNR)—i.e., VTF 201 calculates: PSNR=20 log₁₀ (Max/(MSE)^{1/2}), where Max is a predetermined maximum signal value. The PSNR also provides a similarity measure that indicates the similarity between picture A and picture B. In other embodiments, the similarity measure is a structural similarity (SSIM) metric or a multi-scale SSIM (MS-SSIM) metric as is known in the art of image processing.

In another embodiment, for each input picture, VTF 201 obtains (e.g., calculates) a similarity measure that indicates the degree to which the content of the picture is similar to the content of one or more other pictures (previous or future pictures). The content of a picture can be detected by, for example, a machine vision algorithm. If the content is similar enough to the content of one or more of the other pictures (e.g., if the similarity measure is greater than a threshold), the VTF 201 may decide that the picture is a low priority picture. As an example, the machine vision task can detect an object in picture 0 and also detect the same object in picture 1. If the object has not moved more than a certain distance between picture 0 and picture 1, such as a few pixels, VTF 201 may decide that picture 1 is unnecessary because reusing picture 0 in the decoder will produce a very similar result which is good enough, and, as a consequence VTF 201 decides that picture 1 as a low priority picture.

In another embodiment, VTF 201 analyzes a part of or the entire the video sequence and decides, based on the speed of the events in that part of the video sequence, that every n-th picture is a low priority picture.

In another embodiment, for each input picture, the default decision in the VTF 201 that the picture is low priority unless a condition is satisfied.

For example, in one embodiment, a picture will be determined to be low priority unless: i) VTF 201 detects a new object in the picture (e.g., the picture includes an object, such as a red balloon, and none of the previous M pictures included the object, where M is an integer >0): ii) VTF 201 detects a new overlap area between two objects: iii) VTF 201 detects a previously defined event like object A hitting object B: iv) VTF 201 detects a previously defined event like object A going outside a defined area in the video picture; and/or v) VTF 201 detects a change in the predicted trajectory of an object.

As another example, for each input picture, VTF 201 performs a machine vision task on the picture (and may be together with some other pictures) and based on the output of the machine vision task, VTF 201 decides that the picture is not low priority.

As another example, the condition is satisfied if the number of the low priority pictures has reached a preset limit. In one example, the maximum number of the pictures that can be considered as low priority in a row is set to N and when VTF 201 decides that N consecutive pictures are low priority, VTF 201 will decide that the picture N+1 is not low priority.

As another example, all pictures are low priority with the exception of so-called “key-pictures.” In one embodiment, a key picture is any picture that is of a certain picture type or includes a certain slice type in a predefined GOP structure. In one example, all I-frames in a GOP structure (or alternatively pictures including one or more I-slices) are designated as key-pictures. In another example, a picture is a key picture so long as the picture is not a B-frame (i.e., an I-frame and a P-frame are key-pictures).

In one embodiment, the video is encoded using a two-pass scheme. In the first pass, each picture of the video is analyzed. A decision on whether or not a picture is a key-picture is made based on one or more of but not limited to: i) a new event or object being detected in the picture, ii) a similarity measure indicating a significant difference between the picture and one or more previous picture(s), and/or iii) a neural network for determining key-pictures indicating that the current picture should be used as a key-picture. In the second pass, the key-pictures are encoded into the bit stream.

In one embodiment, when low priority pictures are dropped, the encoder may temporarily drop the frame rate. As an example, the encoder can output a video stream at 60 frames per second (fps), but when some conditions are met, it goes down to 30 fps by dropping every other picture. In an alternative embodiment, the encoder may not drop the low priority pictures, but rather “skip” the fame—that is, encode the low priority pictures as inexpensively as possible. A typical way to do this is to encode all blocks in the low priority picture with motion vector 0. This will result in a picture that has exactly the same content as the previous picture. This way, the encoder can retain a constant frame rate of 60 fps, which can be necessary to cater for certain decoders that are not capable of handling varying frame rates. This way of signaling a picture using skip is not completely free, but typically a lot less expensive in terms of bits than encoding it as a regular picture.

In one embodiment, the low priority pictures are not dropped or skipped, but rather are encoded using a higher QP value, indicating a lower visual quality. Just as in the case when low priority pictures are encoded with skip, this would have the side-effect that the bit rate can be reduced without changing the frame rate. However, in this embodiment, the low priority pictures will often not be identical to the previous picture, which can be helpful since it may roughly preserve the motion in the sequence. This can be helpful especially if the video is going to be viewed by humans in addition to being processed by machine vision algorithms

### Decoder Functionality:

In one embodiment, decoder 104 is configured to use rules to reconstruct machine vision features that are in the low priority pictures. The rules may be (but are not limited to) interpolation rules, extrapolation rules or a defined trajectory.

In embodiment the rules for reconstructing the features in the low priority pictures are defined on the encoder side and sent to the decoder either in the thinned bitstream (in-band) or through another channel (out-of-band). Decoder 104 decodes the bitstream to produce decoded picture, and, using the decoded pictures and the received rules, decoder 104 reconstructs the machine vison features in the low priority pictures.

### Interpolation Rule Example

In one example, from the sequence of pictures A, B and C on the encoder side, picture B is determined to be a low priority picture and, as a result, encoder 102 drops picture B. Pictures A and C are encoded and the encoded pictures A and C sent to decoder 104 together with an interpolation rule. Decoder 104 decodes encoded pictures A and C, and, using the interpolation rule, the features extracted from decoded pictures A and C are interpolated to reconstruct the features in picture B.

### Extrapolation Rule Example

In one example, from the sequence of input pictures A and B on the encoder side, picture B is decided to be dropped by the encoder. Picture A is encoded and sent together with an extrapolation rule indicating a certain change in the location of a feature relative to the location of a feature X in picture A. Decoder 104 decodes picture A and calculates the location of the feature in dropped picture B using the location of feature X extracted from picture A and the decoded extrapolation rules. The position of the feature X′ in picture B is determined by applying the extrapolation rules to the position of feature X in picture A. For example, picture A may include an object (e.g. a football that was kicked) and picture B may also include the object. The encoder can include in the bitstream a delta-y value and a delta-x value and the decoder can determine the position of the football in picture B by calculating x+delta-x and y+delta-y, where x,y is the position of the football in picture A.

In one embodiment, the rule(s) is not signalled to decoder 104 but are assumed (e.g., decoder 104 is pre-configured with the rules). In one example, the position of a machine vision feature in a dropped picture is always assumed to be the average of the position of the features in the pictures right before and right after the dropped picture.

In another example, from the sequence of input pictures A, B, C and D at the encoder, the encoder decides to drop pictures B and C. A feature X in picture A (e.g., an object in picture A such as a football) is moving to a new position in picture D. Trajectory information indicating path the object takes in going from the location in picture A to the location in picture D is encoded into the bit stream. Using the trajectory information included in the bitstream, the decoder can determine the position of the football in the dropped picture B and the position of the football in the dropped picture C. For example, in embodiment, assuming the trajectory of the object is a circular path where the all points are equally spaced apart along the circumference of the circle, then the trajectory information only need include the center point of the circle because the decoder can itself determine the position of the feature in pictures A and D and the decoder can use basic geometry to calculate the position of the feature in pictures B and C once the decoder knows the center of the circle and the position of the feature in pictures A and D. In another embodiment where the feature is a projectile, the trajectory information identifies a first polynomial for determining the y coordinate of the projectile (e.g., y=−4.9t²+5t+7) and a second polynomial for determining the x coordinate of the projectile (e.g., x=.8t). In this projectile embodiment, pictures A and D can also be dropped.

### Adapting Existing Codecs

In one embodiment the picture skips are signalled in the bitstream. In one embodiment, the rules for reconstructing features in the dropped pictures are signalled in the bitstream, for instance in an Supplemental Enhancement Information (SEI) message. In one embodiment, the location of the dropped pictures and the rules for reconstructing features in the dropped pictures are signalled in the bitstream, for instance in an SEI message.

### Changing the GOP Size or Structure

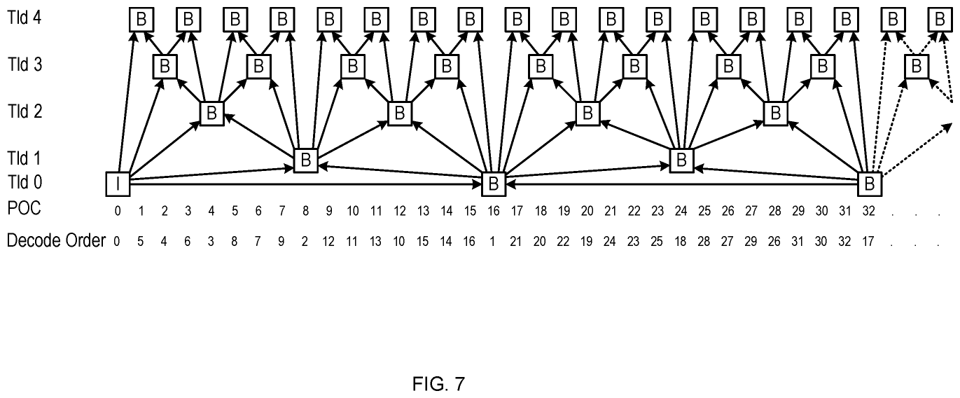

In one embodiment, encoder 102 modifies the GOP structure for the thinned video sequence. As an example, encoder 102 can have the default hierarchical GOP-structure being the one shown in FIG. 7. However, when the encoder decides that the video can be thinned, this GOP-structure can be replaced by, for example:
(1) A simple IPPPPP . . . block structure where all P-frames predict from the previous picture (this can be good if the encoder decides that all pictures in a GOP except the first should be dropped);
(2) A GOP structure with the same structure but different values of QPs;
(3) A GOP structure with fewer pictures;
(4) A GOP structure with a different number of temporal sub layers; and
(5) A GOP structure that is asymmetric, for example using multiple temporal sub layers for some part of the GOP but only a single temporal sub layer for another part of the GOP.

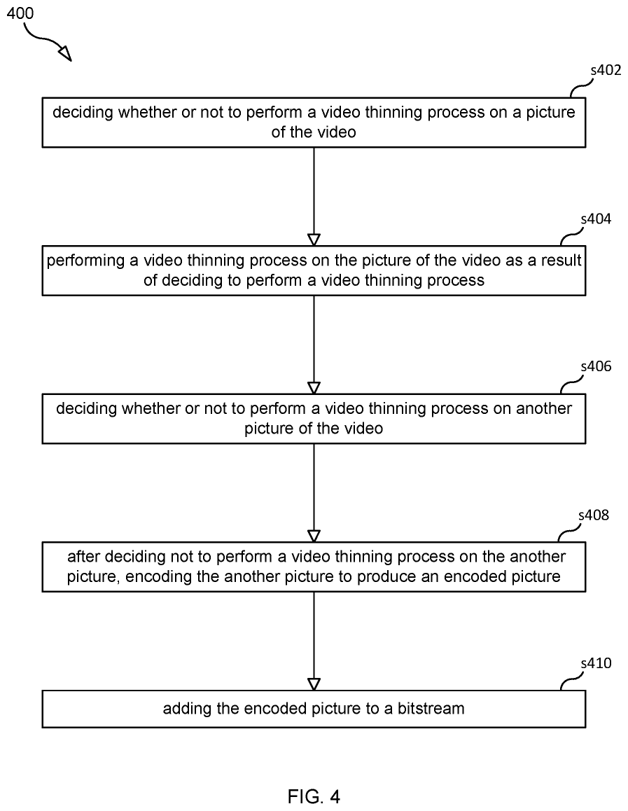

FIG. 4 is a flowchart illustrating a video encoding process 400 performed by encoder 102. Process 400 may begin in step s402.

Step s402 comprises deciding whether or not to perform a video thinning process on a picture of the video.

Step s404 comprises performing a video thinning process on the picture of the video as a result of deciding to perform a video thinning process.

Step s406 comprises deciding whether or not to perform a video thinning process on another picture of the video.

Step s408 comprises, after deciding not to perform a video thinning process on the another picture, encoding the another picture to produce an encoded picture.

Step s410 comprises adding the encoded picture to a bitstream.

In some embodiments, performing the video thinning process on the picture comprises dropping the picture, skipping the picture, encoding the picture using a quantization parameter, QP, value associated with low priority pictures, or encoding the picture to produce a low resolution encoded picture.

In some embodiments, the picture comprises a set of luma values and a set of chroma values, and performing the video thinning process on the picture comprises setting at least a subset of the luma values to a predetermined luma value and setting at least a subset of the chroma values to a predetermined chroma value.

In some embodiments, deciding whether or not to perform a video thinning process on the picture comprises determining the pictures picture order count, POC, and using the POC to decide whether or not to perform a video thinning process on the picture. In some embodiments, using the POC to decide whether or not to perform a video thinning process on the picture comprises determining whether the POC is a multiple of N, where N is a predefined integer greater than or equal to 2. In some embodiments, the video encoder performs the video thinning process on every n-th picture.

In some embodiments, the video encoding process also includes obtaining machine vision task information indicating that a machine vision application will process the encoded picture, wherein deciding whether or not to perform a video thinning process on the picture of the video comprises using the machine vision task information in deciding whether or not to perform a video thinning process on the picture. In some embodiments, the machine vision task information identifies a machine vision task, and using the machine vision task information in deciding whether or not to perform a video thinning process on the picture comprises using a threshold value for the identified machine vision task in deciding whether or not to perform a video thinning process on the picture. In some embodiments, the machine vision task is one of: an object detection task, an object tracking task, an object segmentation task, an event detection task.

In some embodiments, the machine vision task is an event detection task, and the event detection task comprises one or more of: detection of a new object, detection of a new overlap area between two objects, detection of a previously defined event like object A hitting object B, detection of a previously defined event like object A going outside a defined area in the video frame, or detection of a change in the predicted trajectory of an object.

In some embodiments, deciding whether or not to perform a video thinning process on the picture comprises obtaining a similarity measure indicating a similarity between the picture and one or more other pictures of the video.

In some embodiments, deciding whether or not to perform a video thinning process on the picture comprises obtaining a similarity measure indicating a similarity between the content of the picture and the content of one or more other pictures of the video.

In some embodiments, deciding whether or not to perform a video thinning process on the picture comprises using a neural network for determining applicability of the video thinning process to the picture based on a machine vision task.

In some embodiments, the video encoding process also includes encoding one or more syntax elements into the bitstream, wherein the one or more syntax elements specifies a rule for reconstructing at least one machine vision feature of the picture. In some embodiments, the rule is one or more of: an interpolation rule, an extrapolation rule, or a defined trajectory.

In some embodiments, the one or more syntax elements specifying the rule are signaled in a Supplemental Enhancement Information, SEI, message in the bitstream.

In some embodiments, the one or more syntax elements specifying the rule further specify a location of the picture (e.g., the picture's POC).

In some embodiments, the video encoding process also includes using a modified group-of-picture, GOP, size or structure as a result of the performing the video thinning process.

In some embodiments, performing the video thinning process on the picture comprises skipping the picture and skipping the picture comprises encoding a frame skip syntax element into the bitstream.

In some embodiments, the picture of the video belongs to a group of pictures (GOP). An example GOP is illustrated in FIG. 7. As shown in FIG. 7, each picture in the group is associated with a temporal sublayer identifier. In some embodiments, the video encoding process further includes, as a result of deciding to perform the video thinning process on the picture, performing a video thinning process on each picture in the group that is associated with a temporal sublayer identifier that is greater than the temporal sublayer identifier of the picture. In some embodiments, the process further comprises, as a result of deciding to perform the video thinning process on the picture, performing a video thinning process on each picture in the group that it associated with a temporal sublayer identifier that is equal to the temporal sublayer identifier of the picture.

In some embodiments, the picture of the video belongs to a group of pictures, one or more pictures in the group are dependent on the picture, and the video encoding process further comprises, as a result of deciding to perform the video thinning process on the picture, performing a video thinning process on each picture included in the group that is dependent on the picture.

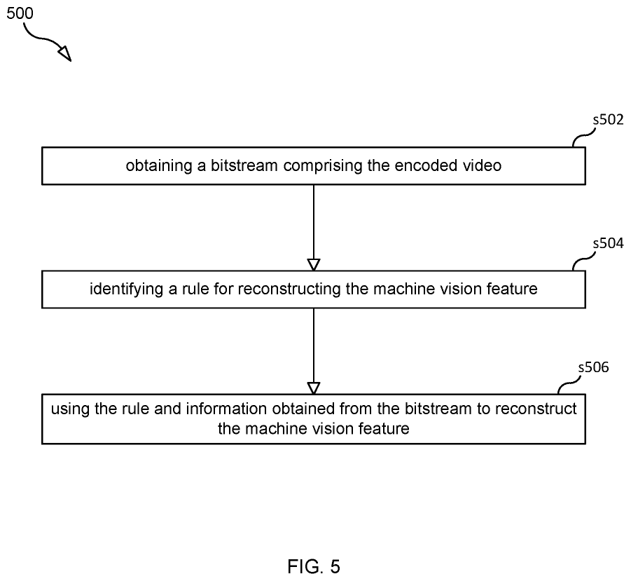

FIG. 5 is a flowchart illustrating a process 500 performed by decoder 104. Process 500 may begin in step s502.

Step s502 comprises obtaining a bitstream comprising the encoded video.

Step s504 comprises identifying a rule for reconstructing the machine vision feature.

Step s506 comprises using the rule and information obtained from the bitstream to reconstruct the machine vision feature.

In some embodiments, identifying the rule comprises decoding from the bitstream one or more syntax elements, wherein the one or more syntax elements specifies the rule. In some embodiments, the one or more syntax elements are included in a Supplemental Enhancement Information (SEI) message.

In some embodiments, the rule is one or more of: an interpolation rule, an extrapolation rule, or a defined trajectory.

In some embodiments, the rule is an interpolation rule, the information obtained from the bitstream comprises an encoded version of a second picture of the video and an encoded version of a third picture of the video, and using the rule and the information obtained from the bitstream to reconstruct the machine vision feature comprises: decoding the second picture and extracting a first feature from the decoded second picture: decoding the third picture and extracting a second feature from the decoded third picture; and interpolating the extracted features to reconstruct the machine vision feature.

In some embodiments, the rule is an extrapolation rule, the information obtained from the bitstream comprises an encoded version of a second picture of the video, and using the rule and the information obtained from the bitstream to reconstruct the machine vision feature comprises: decoding the second picture and extracting a first feature from the decoded second picture: determining a location of a first feature extracted from the second picture; and calculating a location of the machine vision feature using: i) the location of the first feature extracted from the second picture and ii) the extrapolation rule.

In some embodiments, the rule is a defined trajectory, the information obtained from the bitstream comprises an encoded version of a second picture of the video and an encoded version of a third picture of the video, and using the rule and the information obtained from the bitstream to reconstruct the machine vision feature comprises: decoding the second picture and extracting a first feature from the decoded second picture: decoding the third picture and extracting a second feature from the decoded third picture; and applying the defined trajectory to reconstruct the machine vision feature.

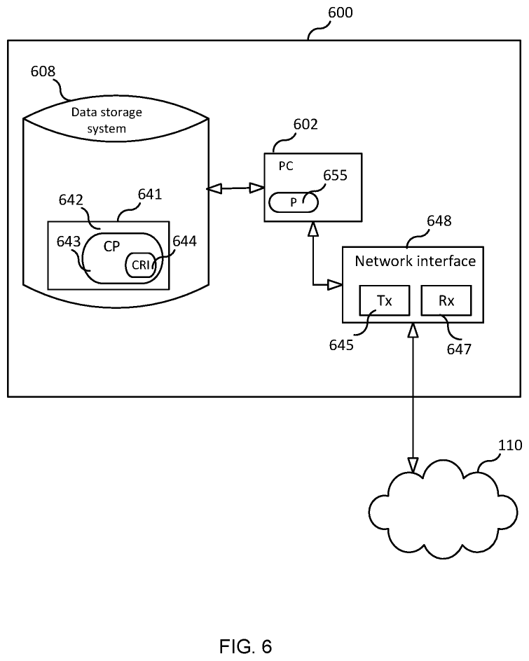

FIG. 6 is a block diagram of an apparatus 600 for implementing encoder 102 and/or decoder 104, according to some embodiments. When apparatus 600 implements a decoder, apparatus 600 may be referred to as a “decoding apparatus 600,” and when apparatus 600 implements an encoder, apparatus 600 may be referred to as an “encoding apparatus 600.”

As shown in FIG. 6, apparatus 600 may comprise processing circuitry (PC) 602, which may include one or more processors (P) 655 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed. That is, apparatus 600 may be a distributed computing apparatus. For example, some processors of the apparatus may be used to implement VTF 201 while other processor of the apparatus may be used to implement the conventional video encoding functions and these processors may or may not be co-located.

Apparatus 600 may further comprise at least one network interface 648 comprising a transmitter (Tx) 645 and a receiver (Rx) 647 for enabling apparatus 600 to transmit data to and receive data from other nodes connected to a network 110 (e.g., an Internet Protocol (IP) network) to which network interface 648 is connected (directly or indirectly) (e.g., network interface 648 may be wirelessly connected to the network 110, in which case network interface 648 is connected to an antenna arrangement); and a storage unit (a.k.a., “data storage system”) 608, which may include one or more non-volatile storage devices and/or one or more volatile storage devices. In embodiments where PC 602 includes a programmable processor, a computer program product (CPP) 641 may be provided. CPP 641 includes a computer readable medium (CRM) 642 storing a computer program (CP) 643 comprising computer readable instructions (CRI) 644. CRM 642 may be a non-transitory computer readable medium, such as, magnetic media (e.g., a hard disk), optical media, memory devices (e.g., random access memory, flash memory), and the like. In some embodiments, the CRI 644 of computer program 643 is configured such that when executed by PC 602, the CRI causes apparatus 600 to perform steps described herein (e.g., steps described herein with reference to the flow charts). In other embodiments, apparatus 600 may be configured to perform steps described herein without the need for code. That is, for example, PC 602 may consist merely of one or more ASICs. Hence, the features of the embodiments described herein may be implemented in hardware and/or software.

### Summary of Various Embodiments

A1. A method for thinning a video comprising a sequence of pictures, the method comprising: deciding whether or not to perform a video thinning process on a picture of the video: performing a video thinning process on the picture of the video as a result of deciding to perform a video thinning process: deciding whether or not to perform a video thinning process on another picture of the video: after deciding not to perform a video thinning process on the another picture, encoding the another picture to produce an encoded picture; and adding the encoded picture to a bitstream.

A2. The method of embodiment A1, wherein performing the video thinning process on the picture comprises dropping the picture.

A3. The method of embodiment A1, wherein performing the video thinning process on the picture comprises skipping the picture.

A4. The method of embodiment A1, wherein performing the video thinning process on the picture comprises encoding the picture using a quantization parameter, QP, value associated with low priority pictures.

A5a. The method of embodiment A1, wherein performing the video thinning process on the picture comprises encoding the picture to produce a low resolution encoded picture.

A5b. The method of embodiment A1, wherein performing the video thinning process on the picture comprises encoding the picture to produce a an encoded picture having a lower resolution than the encoded picture produced by encoding the another picture.

A6. The method of embodiment A1, wherein the picture comprises a set of luma values and a set of chroma values, and performing the video thinning process on the picture comprises setting at least a subset of the luma values to a predetermined luma value and setting at least a subset of the chroma values to a predetermined chroma value.

A7. The method of any one of embodiments A1-A6, wherein deciding whether or not to perform a video thinning process on the picture comprises determining the picture's picture order count, POC, and using the POC to decide whether or not to perform a video thinning process on the picture.

A8. The method of embodiment A7, wherein using the POC to decide whether or not to perform a video thinning process on the picture comprises determining whether the POC is a multiple of N, where N is a predefined integer greater than or equal to 2.

A9. The method of any one of embodiments A1-A8, wherein the video thinning process is performed on every n-th picture.

A10. The method of any one of embodiments A1-A9, further comprising: obtaining machine vision task information indicating that a machine vision application will process the encoded picture, wherein deciding whether or not to perform a video thinning process on the picture of the video comprises using the machine vision task information in deciding whether or not to perform a video thinning process on the picture.

A11. The method of embodiment A10, wherein the machine vision task information identifies a machine vision task, and using the machine vision task information in deciding whether or not to perform a video thinning process on the picture comprises using a threshold value for the identified machine vision task in deciding whether or not to perform a video thinning process on the picture.

A12. The method of embodiment A11, wherein the machine vision task is at least one of: an object detection task, an object tracking task, an object segmentation task, or an event detection task.

A13. The method of embodiment A11, wherein the machine vision task is an event detection task, and the event detection task comprises one or more of: detection of a new object, detection of a new overlap area between two objects, detection of a previously defined event like object A hitting object B, detection of a previously defined event like object A going outside a defined area in the video frame, or detection of a change in the predicted trajectory of an object.

A14. The method of any one of embodiments A1-A13, wherein deciding whether or not to perform a video thinning process on the picture comprises obtaining a similarity measure indicating a similarity between the picture and one or more other pictures of the video.

A15. The method of any one of embodiments A1-A13, wherein deciding whether or not to perform a video thinning process on the picture comprises obtaining a similarity measure indicating a similarity between the content of the picture and the content of one or more other pictures of the video.

A16. The method of any one of embodiments A1-A15, wherein deciding whether or not to perform a video thinning process on the picture comprises using a neural network for determining applicability of the video thinning process to the picture based on a machine vision task.

A17. The method of any one of embodiments A1-A16, further comprising encoding one or more syntax elements into the bitstream, wherein the one or more syntax elements specifies a rule for reconstructing at least one machine vision feature of the picture.

A18. The method of embodiment A17, wherein the rule is one or more of: an interpolation rule, an extrapolation rule, or a defined trajectory.

A19. The method of embodiment A17 or A18, wherein the one or more syntax elements specifying the rule are signaled in a Supplemental Enhancement Information, SEI, message in the bitstream.

A20. The method of any one of embodiments A17-A19, wherein the one or more syntax elements specifying the rule further specify a location of the picture (e.g., the picture's POC).

A21. The method of any one of embodiments A1-A20, further comprising using a modified group-of-picture, GOP, size or structure as a result of the performing the video thinning process.

A22. The method of any one of embodiments A1-A21, wherein performing the video thinning process on the picture comprises skipping the picture and skipping the picture comprises encoding a frame skip syntax element into the bitstream.

A23. The method of any one of embodiments A1-A22, wherein the picture of the video belongs to a group of pictures, each picture in the group is associated with a temporal sublayer identifier, and the method further comprises, as a result of deciding to perform the video thinning process on the picture, performing a video thinning process on one or more pictures in the group that is associated with a temporal sublayer identifier that is greater than the temporal sublayer identifier of the picture.

A24. The method of embodiment A23, wherein the method further comprises, as a result of deciding to perform the video thinning process on the picture, performing a video thinning process on each picture in the group that it associated with a temporal sublayer identifier that is equal to the temporal sublayer identifier of the picture.

A25. The method of any one of embodiments A1-A22, wherein the picture of the video belongs to a group of pictures, one or more pictures in the group are dependent on the picture, and the method further comprises, as a result of deciding to perform the video thinning process on the picture, performing a video thinning process on each picture included in the group that is dependent on the picture.

B1. A computer program comprising instructions which when executed by processing circuitry of a video encoding apparatus, causes the video encoding apparatus to perform the method of any one of embodiments A1-A25.

B2. A carrier containing the computer program of embodiment B1, wherein the carrier is one of an electronic signal, an optical signal, a radio signal, and a computer readable storage medium.

C1. A video encoding apparatus, the video encoding apparatus being adapted to: decide whether or not to perform a video thinning process on a picture of the video; perform a video thinning process on the picture of the video as a result of deciding to perform a video thinning process: decide whether or not to perform a video thinning process on another picture of the video: after deciding not to perform a video thinning process on the another picture, encode the another picture to produce an encoded picture; and add the encoded picture to a bitstream.

C2. The video encoding apparatus of embodiment C1, wherein the video encoding apparatus is further adapted to perform the method of any one of embodiments A2-A25.

D1. A video encoding apparatus comprising: processing circuitry; and a memory, the memory containing instructions executable by the processing circuitry, whereby the video encoding apparatus is operative to perform the method of any one the embodiments A1-A25.

F1. A video decoding method performed by a video decoder for decoding an encoded video, wherein at least one picture of the video was subject to a video thinning process and the picture included a machine vision feature, the method comprising: obtaining a bitstream comprising the encoded video: identifying a rule for reconstructing the machine vision feature: using the rule and information obtained from the bitstream to reconstruct the machine vision feature.

F2. The method of embodiment F1, wherein identifying the rule comprises decoding from the bitstream one or more syntax elements, wherein the one or more syntax elements specifies the rule.

F3. The method of embodiment F2, wherein the one or more syntax elements are included in a Supplemental Enhancement Information, SEI, message.

F4. The method of embodiment F1, F2 or F3, wherein the rule is one or more of: an interpolation rule, an extrapolation rule, or a defined trajectory.

F5. The method of any one of embodiments F1-F3, wherein the rule is an interpolation rule, the information obtained from the bitstream comprises an encoded version of a second picture of the video and an encoded version of a third picture of the video, and using the rule and the information obtained from the bitstream to reconstruct the machine vision feature comprises: decoding the second picture and extracting a first feature from the decoded second picture: decoding the third picture and extracting a second feature from the decoded third picture; and interpolating the extracted features to reconstruct the machine vision feature.

F6. The method of any one of embodiments F1-F3, wherein the rule is an extrapolation rule, the information obtained from the bitstream comprises an encoded version of a second picture of the video, and using the rule and the information obtained from the bitstream to reconstruct the machine vision feature comprises: decoding the second picture and extracting a first feature from the decoded second picture: determining a location of a first feature extracted from the second picture; and calculating a location of the machine vision feature using: i) the location of the first feature extracted from the second picture and ii) the extrapolation rule.

F7. The method of any one of embodiments F1-F3, wherein the rule is a defined trajectory, the information obtained from the bitstream comprises an encoded version of a second picture of the video and an encoded version of a third picture of the video, and using the rule and the information obtained from the bitstream to reconstruct the machine vision feature comprises: decoding the second picture and extracting a first feature from the decoded second picture: decoding the third picture and extracting a second feature from the decoded third picture; and applying the defined trajectory to reconstruct the machine vision feature.

G1. A computer program comprising instructions which when executed by processing circuitry of a video decoding apparatus, causes the video decoding apparatus to perform the method of any one of embodiments F1-F7.

G2. A carrier containing the computer program of embodiment G1, wherein the carrier is one of an electronic signal, an optical signal, a radio signal, and a computer readable storage medium.

H1. A video decoding apparatus, the video decoding apparatus being adapted to: obtain a bitstream comprising the encoded video; identify a rule for reconstructing the machine vision feature: use the rule and information obtained from the bitstream to reconstruct the machine vision feature.

H2. The video decoding apparatus of embodiment H1, wherein the video decoding apparatus is further adapted to perform the method of any one of embodiments F2-F7.

I1. A video decoding apparatus comprising: processing circuitry; and a memory, the memory containing instructions executable by the processing circuitry, whereby the video decoding apparatus is operative to perform the method of any one the embodiments F1-F7.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1-42. (canceled)

43. A method for thinning a video comprising a sequence of pictures comprising at least a first picture and a second picture, the method comprising:
deciding whether or not to perform a video thinning process on a picture of the sequence of pictures by analyzing at least the first picture using a machine vision task;
performing a video thinning process on the first picture as a result of deciding to perform a video thinning process;
encoding the first picture based on the video thinning process to produce a first encoded picture;
adding the first encoded picture to a bitstream;
deciding whether or not to perform a video thinning process on the second picture of the sequence of pictures;
after deciding not to perform a video thinning process on the second picture, encoding the second picture to produce a second encoded picture; and
adding the second encoded picture to the bitstream.

44. The method of claim 43, wherein performing the video thinning process on the picture comprises one or more of:
skipping the picture;
encoding the picture using a quantization parameter (QP) value associated with low priority pictures that is higher than a QP associated with high priority pictures;
encoding the picture to produce an encoded picture having a lower resolution than the encoded picture produced by encoding the another picture; and
where the picture comprises a set of luma values and a set of chroma values, setting at least a subset of the luma values to a predetermined luma value and setting at least a subset of the chroma values to a predetermined chroma value.

45. The method of any claim 43, wherein deciding whether or not to perform a video thinning process on the picture comprises determining the picture's picture order count, POC, and using the POC to decide whether or not to perform a video thinning process on the picture.

46. The method of claim 45, wherein using the POC to decide whether or not to perform a video thinning process on the picture comprises determining whether the POC is a multiple of N, where N is a predefined integer greater than or equal to 2.

47. The method of claim 43, wherein the machine vision task is at least one of:
an object detection task,
an object tracking task,
an object segmentation task, or
an event detection task.

48. The method of claim 43, wherein the machine vision task is an event detection task, and the event detection task comprises one or more of:
detection of a new object,
detection of a new overlap area between two objects,
detection of a previously defined event like object A hitting object B,
detection of a previously defined event like object A going outside a defined area in the video frame, or
detection of a change in the predicted trajectory of an object.

49. The method of claim 43, wherein deciding whether or not to perform a video thinning process on the picture comprises obtaining a similarity measure indicating a similarity between the picture and one or more other pictures of the video.

50. The method of claim 43, wherein deciding whether or not to perform a video thinning process on the picture comprises obtaining a similarity measure indicating a similarity between the content of the picture and the content of one or more other pictures of the video.

51. The method of claim 43, wherein deciding whether or not to perform a video thinning process on the picture comprises using a neural network for determining applicability of the video thinning process to the picture based on a machine vision task.

52. The method of claim 43, further comprising encoding one or more syntax elements into the bitstream, wherein the one or more syntax elements specifies an interpolation rule, an extrapolation rule, or a defined trajectory for reconstructing at least one machine vision feature of the picture.

53. The method of claim 52, wherein the one or more syntax elements specifying the rule are signaled in a Supplemental Enhancement Information, SEI, message in the bitstream.

54. The method of claim 43, further comprising using a modified group-of-picture, GOP, size or structure as a result of the performing the video thinning process.

55. The method of claim 43, wherein performing the video thinning process on the picture comprises skipping the picture and skipping the picture comprises encoding a frame skip syntax element into the bitstream.

56. The method of claim 43, wherein
the picture of the video belongs to a group of pictures,
each picture in the group is associated with a temporal sublayer identifier, and
the method further comprises, as a result of deciding to perform the video thinning process on the picture, performing a video thinning process on one or more pictures in the group that is associated with a temporal sublayer identifier that is greater than the temporal sublayer identifier of the picture.

57. The method of claim 56, wherein the method further comprises, as a result of deciding to perform the video thinning process on the picture, performing a video thinning process on each picture in the group that it associated with a temporal sublayer identifier that is equal to the temporal sublayer identifier of the picture.

58. The method of claim 43, wherein
the picture of the video belongs to a group of pictures,
one or more pictures in the group are dependent on the picture, and
the method further comprises, as a result of deciding to perform the video thinning process on the picture, performing a video thinning process on each picture included in the group that is dependent on the picture.

59. A non-transitory computer readable storage medium storing a computer program comprising instructions which when executed by processing circuitry of a video encoding apparatus, causes the video encoding apparatus to perform the method of claim 43.

60. A video encoding apparatus, the video encoding apparatus comprising:
processing circuitry; and
a memory, the memory containing instructions executable by the processing circuitry, wherein the video encoding apparatus is operative to perform a method comprising:
deciding whether or not to perform a video thinning process on a picture of the sequence of pictures by analyzing at least the first picture using a machine vision task;
performing a video thinning process on the first picture as a result of deciding to perform a video thinning process;
encoding the first picture based on the video thinning process to produce a first encoded picture;
adding the first encoded picture to a bitstream;
deciding whether or not to perform a video thinning process on the second picture of the sequence of pictures;
after deciding not to perform a video thinning process on the second picture, encoding the second picture to produce a second encoded picture; and
adding the second encoded picture to the bitstream.

61. A video decoding method performed by a video decoder for decoding an encoded video, wherein at least one picture of the video was subject to a video thinning process and the picture included at least one detected object, the method comprising:
obtaining a bitstream comprising the encoded video;
identifying a rule for reconstructing the detected object by decoding one or more syntax elements from the bitstream specifying the rule wherein the rule is one or more of an interpolation rule, an extrapolation rule or a defined trajectory;
using the rule and information obtained from the bitstream to reconstruct the detected object.

62. The method of claim 61, wherein the one or more syntax elements are included in a Supplemental Enhancement Information (SEI) message.

63. The method of claim 61, wherein the rule is one or more of:
an interpolation rule,
an extrapolation rule, or
a defined trajectory.

64. The method of claim 61, wherein
the rule is an interpolation rule,
the detected object is a first detected object,
the information obtained from the bitstream comprises an encoded version of a second picture of the video and an encoded version of a third picture of the video, and
using the rule and the information obtained from the bitstream to reconstruct the detected object comprises:
decoding the second picture and extracting a second detected object from the decoded second picture;
decoding the third picture and extracting a third detected object from the decoded third picture; and
interpolating the extracted second detected object and third detected object to reconstruct the first detected object.

65. The method of claim 61, wherein
the rule is an extrapolation rule,
the detected object is a first detected object,
the information obtained from the bitstream comprises an encoded version of a second picture of the video, and
using the rule and the information obtained from the bitstream to reconstruct the detected object comprises:
decoding the second picture and extracting a second detected object from the decoded second picture;
determining a location of a second detected object extracted from the second picture; and
calculating a location of the first detected object using: i) the location of the first feature extracted from the second picture and ii) the extrapolation rule.

66. The method of claim 61, wherein
the rule is a defined trajectory,
the detected object is a first detected object,
the information obtained from the bitstream comprises an encoded version of a second picture of the video and an encoded version of a third picture of the video, and
using the rule and the information obtained from the bitstream to reconstruct the detected object comprises:
decoding the second picture and extracting a second detected object from the decoded second picture;
decoding the third picture and extracting a third detected object from the decoded third picture; and
applying the defined trajectory to reconstruct the first detected object.

67. A non-transitory computer readable storage medium storing a computer program comprising instructions which when executed by processing circuitry of a video decoding apparatus, causes the video decoding apparatus to perform the method of claim 61.

68. A video decoding apparatus, the video decoding apparatus comprising:
processing circuitry; and
a memory, the memory containing instructions executable by the processing circuitry, whereby the video decoding apparatus is operative to decode an encoded video, wherein at least one picture of the video was subject to a video thinning process and the picture included at least one detected object, the video decoding apparatus being operative, further, to:
obtain a bitstream comprising an encoded video;
identify a rule for reconstructing the detected object by decoding one or more syntax elements from the bitstream specifying the rule wherein the rule is one or more of an interpolation rule, an extrapolation rule or a defined trajectory; and
use the rule and information obtained from the bitstream to reconstruct the detected object.
